(19) United States
(12) Patent Application Publication
(10) Pub. No.: US 2015/0367269 A1
(43) Pub. Date: Dec. 24, 2015

(54) Method for Making a Filtering Element and Filtering Element

(71) Applicant: SARONG SOCIETA' PER AZIONI, Reggiolo (Reggio Emilia) (IT)

(72) Inventors: Andrea Bartoli, Reggio Emilia (IT); Davide Capitini, Reggio Emilia (IT); Alessandro Grillenzoni, Campogalliano (Modena) (IT); Flavio Traldi, San Prospero (Modena) (IT)

(73) Assignee: SARONG SOCIETA' PER AZIONI, Reggiolo (Reggio Emilia) (IT)

(21) Appl. No.: 14/768,055

(22) PCT Filed: Feb. 14, 2014
(86) PCT No.: PCT/IB2014/058994

§ 371 Date: Aug. 14, 2015

(30) Foreign Application Priority Data
Feb. 15, 2013 (IT) MO2013A000035

(51) Int. Cl. B01D 39/16; B01D 29/00; B01D 35/027

(52) U.S. Cl. CPC B01D 39/1623; B01D 35/027; B01D 29/0093

(57) ABSTRACT

A method for making a filtering element from a film of non-woven material, the filtering element being associable with a container for containing and/or retaining a product, including hot pressing at least one defined portion of the film or of the filtering element so as to obtain a pressed portion in which fibres, in particular synthetic and/or plastic fibres, of at least one external surface layer of the non-woven material are compacted and pressed together and in which a thickness of the non-woven material is reduced by a percentage between 30 and 50%.

### FIELD OF THE INVENTION

The invention relates to filtering elements for containers and in particular relates to a method for making a filtering element to be associated with a container or for forming a filtering casing, said filtering element being intended to contain or retain an initial product. The invention further refers to a filtering element that is thus obtained.

In the containers (capsules) or casings (pods) for beverages, used in automatic dispensing machines, the filtering elements contain and/or retain a product to be combined with a liquid to obtain a final product, typically a hot beverage, for example coffee or tea.

### BACKGROUND OF THE INVENTION

Disposable capsules are known, sealed with an internal filtering element, comprising an impermeable external container or casing, glass- or cup-shaped, provided with a bottom wall and with a side wall that define a cavity provided with an upper opening. The latter is closed hermetically by a cover in such a manner as to seal inside the casing the filtering element, or filter, containing the product from which to obtain the final product (beverage) by means of percolation or infusion.

In one type of capsule, to obtain a final product by percolation or infusion of the final product, the filter, which is shaped as a bag in such a manner as to make a respective cavity that is open upwards to contain the initial product, is fixed, in particular welded, to the side wall of the casing at an upper peripheral side thereof that is typically flange-shaped. The filter divides the interior of the casing into a first upper chamber containing the product and which is accessible through the upper opening of the casing (to permit filling thereof) and a second lower chamber, comprised between the filter and the bottom wall and/or the side wall of the casing, which enables the beverage obtained from the initial product to be removed.

In known machines for making capsules for beverages, the filters are formed separately by bending portions of suitable dimensions obtained by cutting or shearing a film of filtering material unwound from a reel. Once the filters have been formed they are then inserted into and fixed to the respective previously formed capsules.

Filtering casings are also known, so-called filtering pods, formed by a folded filtering element, or by two suitably joined filtering elements, in such a manner as to enclose and contain a dose of initial product, typically coffee. The filtering pods are used in the same way as capsules in dispensing machines for dispensing a final product by percolation.

### SUMMARY OF THE INVENTION

Filtering elements are further used in other types of container to separate a cavity or chamber containing a product from an adjacent chamber or from the external environment.

Containers are known for air fresheners that comprise a casing in the form of a bowl or cup that contains a deodorant product and is closed by a filtering or breathable element that prevents the product escaping but allows air to pass and thus the deodorizing essence to be propagated and diffused in the environment.

Containers are known in which a filtering element separates the internal cavity into two or more chambers containing distinct products.

The filtering elements can be made of filter paper, material that is permeable to liquids and to air, is light, thin and can be easily cut.

The filter paper nevertheless has very low resistance to tensile stress, so that in use it can easily lacerate or break. For example, in the case of capsules for beverages, laceration or breaking of the filter and the consequent release of the initial product into the final product is frequent, the final product thus being altered. The pressure of the liquid delivered to the capsule together with the weight of the initial wet product often cause the filter to be lacerated or broken in one or more places and/or the latter to be partially or totally detached from the container.

This drawback is found in pods for beverages, which often tear during extraction from the dispensing machine.

Filtering elements are also known that are made with films or sheets of non-woven material, which has stratified or crossed fibres joined together mechanically, by using adhesives or by thermal processes. The fibres comprise threads of synthetic and/or plastic material, typically threads of polyester, polypropylene and polyamide. The filters made of non-woven material, although they ensure the same performance as the filter paper in terms of filtration, are much more resistant mechanically, in particular to traction.

Many of the filtering elements made of non-woven material have the drawback of being difficult to cut and shear, making it difficult to use them in known machines for making containers provided with filtering elements. Owing to the structure of the light, soft and low-density non-woven material, it is in fact difficult to obtain a clean and precise cut, i.e. obtain portions of film with cut edges that are devoid of protruding threads or partially cut fibres. The filtering elements that are thus obtained and used, for example in the capsules and pods for beverages, are not generally acceptable, both for aesthetic reasons and because of the risk that portions and parts of threads/fibres can become detached during use of the filtering element reaching the final product, thus adulterating the final product.

The mechanical cutting devices generally used have to be very sharp and be frequently replaced to ensure a satisfactory and constant cutting quality, with consequent long machine downtime and high maintenance costs. The use of laser-cutting devices is excessively expensive and is not much suitable for use on machines with a high productive rate.

Filtering elements made of non-woven material are moreover difficult to perforate because the non-woven material tends to become deformed and locally elongated, thus preventing perforation thereof. In capsules provided with filtering elements, the latter are thus not perforable by liquid delivering nozzles of the dispensing machine. The filtering elements are thus formed open, closed above by a cover made with an easily perforable metal or plastic film.

The filtering elements made of non-woven material of great thickness (1-3 mm) and/or low density are then difficult to weld to the walls or to the edges of the corresponding container, requiring long welding time that slows down the productive cycle of the machine, reducing the productivity thereof.

In the field of containers for food, following the requirement to sort solid urban waste, the need has recently emerged to dispose of containers, once they have been used, by separating the containers into components on the basis of the material of which they are made, in particular dividing the external casing of plastic or metal (aluminium) from the internal filter containing a food, i.e. organic, product.

Removing filters in the known containers is nevertheless very complex and difficult because the filter is not graspable directly by the user and being welded to the walls or to the edge of the casing it can be detached only with great difficulty, with the concrete risk of tearing and breaking in the operation, releasing the residual initial product, this entailing problems of hygiene and cleanliness.

An object of the present invention is to improve the known methods for making filtering elements for containers, in particular filtering elements made of non-woven material and intended for containing and/or retaining a product.

Another object is to provide a method that enables a filtering element of non-woven material to be made that is provided with portions that can be cut and sheared cleanly and precisely so as to generate cut edges that are devoid of protruding threads or of portions or residues of detachable threads.

A further object is to provide a method that enables a filtering element made of a non-woven material provided with portions that can be easily perforated and traversed, for example by an injection arrangement of the dispensing machine, to be obtained.

Still another object is to provide a method that enables a filtering element made of non-woven material provided with portions that can be easily and firmly fixed, in particular welded to a respective container, to be made.

Still another object is to make a filtering element that can be firmly fixed to a container in such a manner as not to become detached in use and can at the same time be easily detached and removed from the container by a user in a disposable step after use.

In a first aspect of the invention a method is provided for making a filtering element according to claim 1.

In a second aspect of the invention a filtering element according to claim 12 is provided.

In a third aspect of the invention a container is provided comprising the filtering element of the second aspect and according to claim 15.

### BRIEF DESCRIPTION OF THE DRAWINGS

The invention can be better understood and implemented with reference to the attached drawings that illustrate some embodiments thereof by way of non-limiting example, wherein:

FIG. 1 is a schematic plan view of operating steps of the method of the invention;

FIG. 2 is a cross section of a filtering element of the invention associated with a container;

FIG. 3 is a plan view of a version of the filtering element of the invention;

FIG. 4 is a cross section of the filtering element of FIG. 3 associated with a container;

FIG. 5 is a schematic plan view of the method of the invention for making another version of the filtering element;

FIG. 6 is a cross section of the filtering element of FIG. 5 associated with another container.

### DETAILED DESCRIPTION OF THE INVENTION

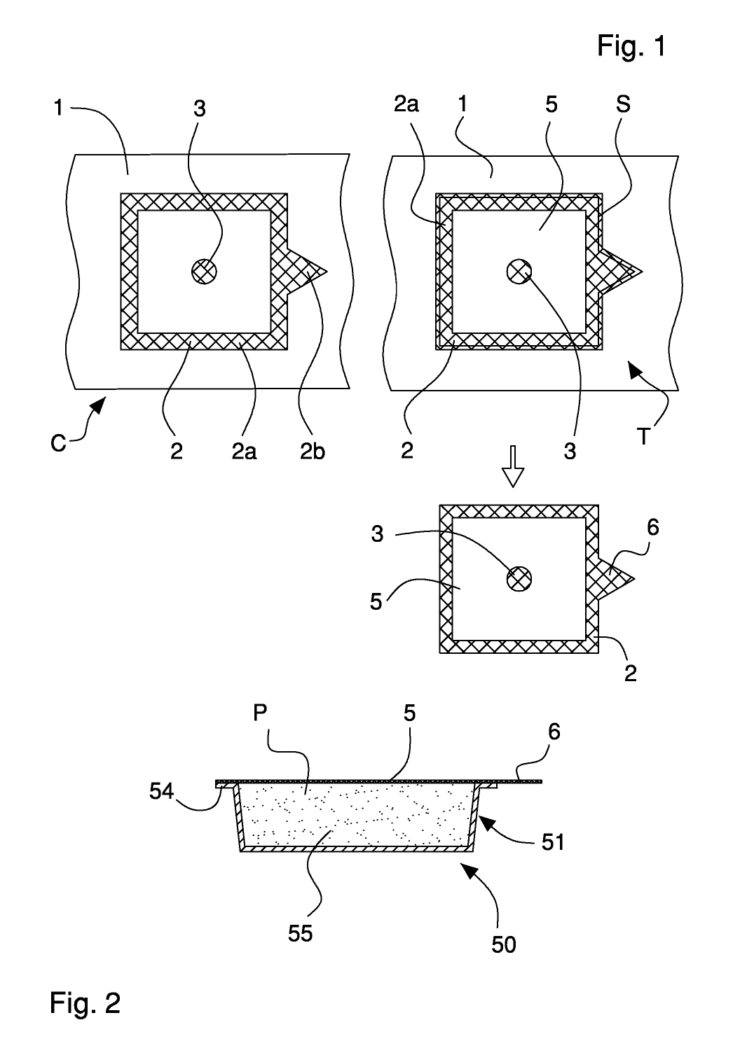

With reference to FIG. 1, there are schematically illustrated the steps of the method of the invention for making a filtering element 5 from a film 1 of non-woven material that is associable with a container, for example a capsule that is usable in a dispensing machine for beverages or a container for air fresheners, or arranged for forming a filtering casing that is suitable for enclosing and containing an initial product, for example a pod that is usable in a dispensing machine for beverages.

The film 1 of non-woven material is a material of known type containing fibres of synthetic and/or plastic material such as nylon, polyester, polyethylene, polypropylene and polyamide joined together, interwoven and/or superimposed by a mechanical or thermal arrangement or by coupling with binding substances.

The film 1 is typically supplied in rolls of various dimensions and thicknesses and is then unwound to be subjected to the various steps of the method.

The method comprises a hot compression step C wherein at least one defined portion of the film 1 is hot pressed that is intended to be contained in the filtering element 5 to be made by a suitable compressing arrangement such as, for example, hot shaped moulds, not illustrated in the figures, in such a manner as to obtain at least one corresponding pressed portion 2 in which the fibres of at least one external surface layer of the non-woven material are compacted and pressed together and in which a thickness of said non-woven material is reduced by a percentage comprised between 30 and 50% with respect to the thickness of the non-compressed non-woven material.

The non-woven material can be hot-pressed on both sides of the film 1 in such a manner that respective fibres of external and opposite surface layers of said non-woven material are pressed and compacted. After hot compression the fibres are substantially alongside and adjacent with a substantial reduction of the passages (pores) between adjacent fibres and thus with a local increase of the density of the non-woven material, which is more compact.

Hot compression is further such as to melt at least partially a respective surface layer of each fibre in such a manner as to join together the fibres, in particular in a reversible manner to enable, in a step after mechanical treatment of the pressed portion 2, the fibres to be separated and removed again, returning the non-woven material to a state that is similar to the original state.

During the compression step, on the defined portion of non-woven material a pressure is exerted that is comprised between 0.1 and 1.0 MPa, in particular comprised between 0.2 and 0.6 MPa, at a temperature comprised between 80° C. and 250° C., in particular comprised between 110° C. and 230° C. for a pressure time comprised between 0.1 sec. and 4 sec., in particular comprised between 0.3 sec. and 1 sec. The pressure, temperature and compression time values vary according to the features of the non-woven material.

Experimental tests have shown that the localised hot pressure of the non-woven material leads to a substantially reversible variation in the physical and mechanical features of said non-woven material in the aforesaid pressed portion 2.

In particular, through the effect of the compacting and partial joining (partial and surface melting) of the fibres of the surface layers of the non-woven material, in the pressed portion 2 there is observed, in addition to a decrease of the thickness, a greater density of the material, greater resistance to tensile stress, to penetration, to cutting and less permeability in relation to liquids. The greater resistance to tensile stress and penetration also cause less pliability and elastic plastic elongation of the non-woven material.

In terms of external appearance, a change of colour is noted (from opaque to shiny) and a variation in consistency (increase in stiffness).

The tests conducted on a plurality of non-woven materials with different combinations of pressure, temperature and pressure time have shown an increase in resistance to tensile stress comprised between 70 and 100%, an increase in resistance to static punching comprised between 60 and 90% and a decrease in the permeability in relation to liquids (ethyl alcohol) comprised between 60 and 80%.

An effect of the hot pressure of the non-woven material is that the latter, after being cooled to a temperature that is not greater than 35°, can be cut or sheared in the pressed portion 2 by a known mechanical arrangement, such as punches and dies, rotating blades or shears, precisely and cleanly so as to generate filtering elements, having cut edges devoid of protruding fibres, or of portions or residues of detachable fibres. In other words, it is possible to obtain by cutting or shearing from a film of non-woven material filtering elements 5 that are associable in containers for innumerable uses.

For example, the filtering elements 5 can be used in capsules for beverages for containing and/or separating an initial product, for example coffee or tea, from which to obtain by means of percolation or infusion a final product, typically a beverage.

The filtering elements of thus cut non-woven material can also be used to close containers that contain a food product or an air freshener or an object.

It is also possible to obtain by cutting or shearing of the film of non-woven material filtering elements that are usable for forming casings or filtering pods that enclose and contain a dose of initial product, typically coffee. The pods can consist of a single filtering element folded and closed peripherally around the dose of initial product.

Owing to the variations in the physical and mechanical features of the non-woven material determined by the hot pressure in the aforesaid pressed portion 2, the latter is thus easily perforable and traversable, for example by a dispensing arrangement of a dispensing machine. The non-woven material has, in fact, in the pressed portion 2 a structure with greater density having greater resistance to tensile stress and punching and less local deformation and elongation, which are features that permit easy perforation thereof.

It should be noted that the variation in the physical and mechanical features of the non-woven material in the aforesaid pressed portion 2 is reversible, at least partially. It has in fact been observed that by subjecting the aforesaid pressed portion 2 to longitudinal and/or transverse traction the fibres of the external surface layers tend to become separated and move away, returning to a configuration that is substantially similar to that of the original non-woven material.

This can be advantageous in a possible subsequent step of treating a filtering element having a pressed portion wherein for example deformation thereof is provided. As deformation of the filtering element cannot be effectively carried out with the same results both in zones of the pressed portion, whose fibres are able to return to a configuration similar to the original non-woven material, and in zones of non-woven material that have not been hot-pressed, the pressed portion can also be made with dimensions that are slightly greater than what is strictly necessary. The localised hot pressure step of the film 1 of non-woven material can thus be performed without strict precision requirements.

Another effect of the hot pressure exerted on films of non-woven material having great thickness (from 1 to 3 mm) and/or having low density is that the pressed portion 2, after hot compression, is easier to weld thermally to the casing of the capsule. By virtue of the reduced thickness and greater density of the non-woven material in the pressed portion it is thus easier to transmit heat to the below casing to activate the welding layer thereof. It is thus possible to reduce considerably welding time, increasing machine productivity and obtaining welding of better quality.

Through the effect of the greater density of the non-woven material in the pressed portion it is further possible to weld the filtering element to the casing of the capsule also through ultrasound welding.

With reference to the steps of the method specified in FIG. 1, in the hot compression step C a pressed portion 2 and a further pressed portion 3 are made. The pressed portion 2 comprises a first annular zone 2a that bounds and defines the shape of the filtering element 5 to be made and at least one second zone 2b intended for making in the filtering element 5 a gripping portion 6 for the user, as explained better below in the description. The further pressed portion 3 is on the other hand intended to form a perforation zone in the filtering element 5.

The method of the invention provides a stabilising step of the shape of said pressed portion by a further compressing arrangement, that is similar to the compressing arrangement used in the hot pressure step but in this case the compressing arrangement is not heated or even cooled. The stabilising step comprises cooling by contact, for example for a time from 0.5 to 4 sec., by means of the further compressing arrangement, the pressed portion 2 until the pressed portion 2 has a temperature below or the same as 35°.

In a cutting step T the film 1 is cut or sheared to obtain the filtering element 5.

The cutting step T is performed after the hot compression step C and after the stabilising step and cutting or shearing is performed at the pressed portion 2, and stabilised, along a cutting line S so as to ensure a clean and precise cut. The filtering element 5 that is thus obtained thus has cleanly cut edges that are devoid of protruding fibres, or of portions or residues of detachable fibres.

The substantially flat filtering element 5 that is thus obtained can be fixed to a peripheral edge 54 of a casing 51 of a container 50 to close a product P inside a cavity 55 of the latter (FIG. 2).

The container 50 is, for example, a container for air fresheners and the filtering element 5 prevents the product P coming out but enables the air to pass and thus the deodorant essence to propagate and diffuse in the environment.

The filtering element 5 can be associated with and also fixed to a capsule, which is not illustrated, which is usable in a dispensing machine to obtain beverages.

The cut made along the pressed portion 2, in particular along the first zone 2a and the second zone 2b, along the cutting line S also enables the gripping portion 6 to be made. The gripping portion 6, in which the non-woven material has been subjected to hot pressure, owing to the increased mechanical performance (greater density and greater resistance to tensile stress) enables the user to detach and remove the filtering element 5 easily from the container 50 without the aforesaid filtering element 5 getting torn or breaking.

In the case of containers or capsules for beverages it is thus possible after use in the dispensing machine to separate easily and effectively the casing 51 made of plastics or metal (aluminium) of the container 50 from the filtering element 5 containing the food and organic product P in such a manner as to meet the requirements of solid urban waste sorting.

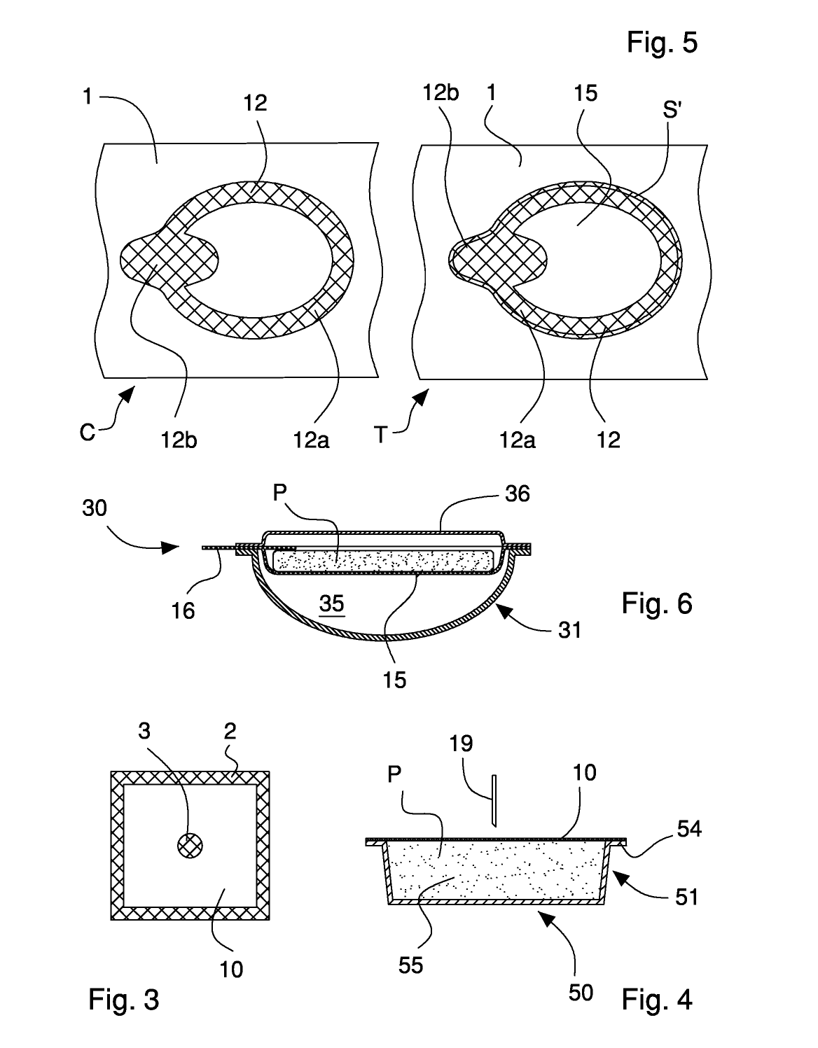

FIG. 3 illustrates a version of the filtering element 10 that is devoid of the gripping portion. The further pressed portion 3 of the filtering element 10 is in this case intended to permit easy perforation by a suitable perforating device 19 for accessing the product P contained in the container 50 to which the filtering element 10 is fixed.

FIG. 5 illustrates the hot compression C and cutting T operating steps of the method of the invention, the stabilising step not being represented, to obtain a version of the filtering element 15 having a substantially elliptic step. Also in this case, by hot-pressing the film 1 a pressed portion 12 is obtained comprising a first annular zone 12a, that bounds and defines the shape of the filtering element 15 to be made, and a second zone 12b intended to make in the filtering element 15 a gripping portion 16 for the user. The second zone 12b extends, in this version of the filtering element 15, inside and outside the first annular zone 12a.

In the cutting step T the cut is performed at the pressed portion 12, and stabilised, along a cutting line S′ so as to ensure a clean and precise cut. The filtering element 15 that is thus obtained has edges sheared cleanly, cut devoid of protruding fibres, or of portions or residues of detachable fibres.

The filtering element 15 can be associated with a container 30 comprising a casing 31 defining a respective cavity 35. The filtering element 15 is formed in such a manner as to make a housing that is suitable for supporting a product P, for example a food product. The container 30 comprises a closing element 36 arranged for closing the cavity 35.

By cutting along the second zone 12b, it is possible to make a gripping portion 16 that extends on opposite sides, outside and inside the casing 31 of the container 30. By grasping the external part of the gripping portion 16 a user can easily detach and separate from the casing 31 the filtering element 15 with the product P. The gripping portion 16, owing to the features of the locally hot-pressed non-woven material, ensures mechanical resistance and prevents tearing of the filtering element 15. It should be noted that the internal part of the gripping portion 16 that protrudes inside the cavity 35 of the container 30 eases and facilitates the detachment of the filtering element from the casing 31 preventing the breakage or tearing thereof.

In one version of the embodiment of the invention that is not illustrated, the non-woven material of the filtering element is hot-pressed after the latter has been cut and detached from the film 1. In this case, the cutting step T precedes the hot compression and stabilisation step C. The hot pressure step can be performed whilst the filtering element is fixed to a respective container. The hot pressure makes a pressed portion that can comprise a gripping portion for enabling the user to detach and remove the filtering element easily from the container or a portion intended to be perforated.

The filtering element can be further used to make a filtering casing, for example a filtering pod for percolatable or infusion products that is suitable for containing a product. The filtering pod can be made by joining together two filtering elements provided with respective pressed portions along which they are joined, for example welded, to enclose and contain the dose of initial product. The pressed portions comprise and form a gripping portion that enables a user to remove the pod from the dispensing machine. The gripping portion, owing to the features of the locally hot-pressed non-woven material, ensures mechanical resistance and prevents laceration of the pod during the operation of extraction from the dispensing machine.

1-15. (canceled)

16. Method for making a filtering element from a film of non-woven material, said filtering element being associable with a container for containing and/or retaining a product, said method comprising hot pressing at least one defined portion of said film or of said filtering element so as to obtain a pressed portion in which fibres, in particular synthetic and/or plastic fibres, of at least one external surface layer of said non-woven material are compacted and pressed together and in which a thickness of said non-woven material is reduced by a percentage comprised between 30 and 50%.

17. Method according to claim 16, wherein said hot pressing comprises pressing on opposite sides said non-woven material in such a manner as to compact and press respective fibres of external and opposite surface layers of said non-woven material.

18. Method according to claim 16, wherein said hot pressing comprises melting at least partially a respective surface layer of each fibre in such a manner as to join together said fibres.

19. Method according to claim 16, wherein said hot pressing comprises exerting on said defined portion a pressure comprised between 0.1 and 1.0 MPa, in particular comprised between 0.2 and 0.6 MPa.

20. Method according to claim 16, wherein said hot pressing comprises pressing said defined portion at a temperature comprised between 80° C. and 250° C., in particular comprised between 110° C. and 230° C.

21. Method according to claim 16, wherein said hot pressing comprises pressing said defined portion for a time comprised between 0.1 sec. and 4 sec., in particular comprised between 0.3 sec. and 1 sec.

22. Method according to claim 16, and comprising stabilising a shape of said pressed portion, wherein said stabilising comprises cooling by contact, for example for a time from 0.5 sec. to 4 sec., said pressed portion until said pressed portion reaches a temperature below 35°.

23. Method according to claim 16, and comprising cutting said film to obtain said filtering element.

24. Method according to claim 23, and comprising stabilising a shape of said pressed portion, wherein said stabilising comprises cooling by contact, for example for a time from 0.5 sec. to 4 sec., said pressed portion until said pressed portion reaches a temperature below 35°, wherein said cutting is made after said stabilising, said cutting comprising cutting said material at said pressed and stabilised portion.

25. Method according to claim 23, wherein said cutting is made before said hot pressing.

26. Method according to claim 16, and comprising cutting said pressed portion to make a gripping portion of said filtering element graspable by a user.

27. Filtering element of non-woven material associable with a container or arranged for forming a filtering casing, said filtering element being arranged for containing and/or retaining a product and comprising at least one hot pressed portion in which fibres, in particular synthetic and/or plastic fibres, of at least one external surface layer of said non-woven material are compacted and pressed together and in which a thickness of said non-woven material is reduced by a percentage comprised between 30 and 50%.

28. Filtering element according to claim 27, wherein said pressed portion comprises two external and opposite surface layers wherein said fibres are compacted and pressed together.

29. Filtering element according to claim 27, wherein in said pressed portion respective surface layers of said fibres are melted at least partially in such a manner as to join together said fibres.

30. Container comprising a casing provided with a cavity suitable for containing or closed by, a filtering element according to claim 27.
